(19) United States
(12) Patent Application Publication
(10) Pub. No.: US 2025/0248574 A1
(43) Pub. Date: Aug. 7, 2025

(54) SEPARATOR UNIT WITH EJECTION AND/OR COMPRESSION FUNCTION AND SUCTION APPARATUS

(71) Applicant: BSH Hausgeräte GmbH, München (DE)

(72) Inventors: Christofer EBERT, Marktheidenfeld (DE); Andre MICHAELIS, Salz (DE); Juri GEBEL, Hohenroth (DE); Jens REINHARDT, Hohenroth (DE); Thomas Eric BELIVEAU, München (DE)

(21) Appl. No.: 19/043,976

(22) Filed: Feb. 3, 2025

(30) Foreign Application Priority Data
Feb. 5, 2024 (DE) 10 2024 201 018.9

(51) Int. Cl. A47L 9/16; A47L 9/12; A47L 9/20; B08B 1/16; B08B 1/30

(52) U.S. Cl. CPC A47L 9/1683; A47L 9/127; A47L 9/1691; A47L 9/20; B08B 1/165; B08B 1/30

(57) ABSTRACT

A separator unit for a suction apparatus contains a collection container with a collection area for receiving particles of dirt from a suction airflow. The collection container runs along a longitudinal axis from a first end side, which during the operation of the suction apparatus faces the blower of the suction apparatus, up to a second end side on which the cover of the collection container is arranged. The separator unit contains a filter module arranged in the collection container and is configured to filter particles of dirt out of the suction airflow. The collection area is adjacent to the surface of the filter module and the filter module is configured so as on the first end side of the collection container to be removed from the collection container or to be inserted into the collection container.

### CROSS-REFERENCE TO RELATED APPLICATION

This application claims the priority, under 35 U.S.C. § 119, of German Patent Application DE 102024201018.9, filed Feb. 5, 2024; the prior application is herewith incorporated by reference in its entirety.

### FIELD AND BACKGROUND OF THE INVENTION

The invention relates to a suction apparatus, such as a hand-held vacuum cleaner. In particular, the invention relates to a separator unit for a suction apparatus which renders it possible to conveniently and reliably compress dirt in the collection area and/or to empty the collection area of the separator unit.

A suction apparatus, in particular a hand-held vacuum cleaner, typically contains a separator unit with a filter module that is configured to separate particles of dust from the suction air of the suction apparatus and to collect the particles of dust in a collection area of the separator unit. The separator unit can be configured in such a manner that the collection area is designed as a ring around a cylindrical filter module and that a cyclone-like suction airflow is created in the collection area. This can result in hairs wrapping around the filter module during the suction operation of the suction apparatus and it is usually not possible to remove the hairs from the filter module and the collection area of the separator unit in a convenient manner. It is frequently necessary, in order to empty and/or clean the separator unit, that the separator unit is decoupled from the suction apparatus and/or that the filter module is removed from the separator unit. This can be perceived by a user of the suction apparatus as inconvenient and unhygienic.

### SUMMARY OF THE INVENTION

The present document concerns the technical object of providing a separator unit for a suction apparatus which renders it possible to conveniently and thoroughly compress the dirt and also to conveniently and thoroughly empty and/or clean the separator unit, in particular the filter module and/or the collection area.

The object is achieved by means of the subject matter of the independent claims. Advantageous embodiments are defined in particular in the dependent claims, described in the description below or illustrated in the attached drawing.

With the foregoing and other objects in view there is provided, in accordance with the invention, a separator unit for a suction apparatus. The separator unit contains a collection container with a collection area for receiving particles of dirt from a suction airflow of the suction apparatus. The collection container extends along a longitudinal axis from a first end side, which during an operation of the suction apparatus faces a blower of the suction apparatus, up to a second end side on which a cover of the collection container is disposed. A filter module is disposed in the collection container and configured to filter the particles of dirt out of the suction airflow. The collection area is adjacent to a surface of the filter module. The filter module is configured so as on the first end side of the collection container to be removed from the collection container or to be inserted into the collection container. A scraper element is configured so as to slide over the surface of the filter module when the filter module on the first end side of the collection container is removed from the collection container.

In accordance with one aspect, a separator unit for a suction apparatus (in particular for a cyclone-based suction apparatus, such as for a hand-held vacuum cleaner) is described. The separator unit can be configured as a cyclonic separator.

The separator unit contains a collection container with a collection area for receiving particles (of dirt and/or dust) from the suction airflow of the suction apparatus. The collection container can have the shape of a cylinder, in particular a circular cylinder. Moreover, the collection container can extend along a longitudinal axis from a first end side, which is facing the blower of the suction apparatus, up to a second end side, wherein a cover can be arranged on the second end side for emptying the collection container. The longitudinal axis can correspond to the vertical axis of the cylindrical container.

The separator unit also contains a filter module which is arranged in the collection container and is configured to filter particles out of the suction airflow. In this case, the collection area of the collection container can be adjacent to the surface of the filter module. In other words, the surface of the filter module can represent a delimitation of the collection area. The surface of the filter module can correspond to the outer surface of a cylinder, in particular a circular cylinder. The collection area can thus be arranged in an annular manner around the filter module.

The surface of the filter module can be formed by a sieve (or by a lint filter). The sieve can encompass a dust filter.

The suction airflow can pass from the suction mouth of the suction apparatus into the collection container, in particular into the collection area of the collection container. The suction airflow can then pass through the surface of the filter module to the central longitudinal axis of the filter module. In so doing, the particles are retained by the filter module. After passing through the filter module, the suction airflow can be directed to the blower of the suction apparatus and out of the suction apparatus. The suction airflow can have a cyclone-like flow behavior about the (central) longitudinal axis within the collection area of the collection container.

The separator unit also contains a scraper element which is designed to be moved (along the longitudinal axis) over the surface of the filter module in order to clean the surface of the filter module. In this case, the scraper element can comprise a scraper ring, in particular it can be a scraper ring, which encompasses the outer surface of the (cylindrical) filter module in the circumferential direction.

The surface of the filter module can have a specific total length along the longitudinal axis. The scraper element can extend along the longitudinal axis over a length which corresponds to 20% or less (for example between 2% and 10%) of the total length. It is thus possible to create a significant movement of the scraper element for thoroughly cleaning the surface of the filter module.

The scraper element can have a spatial extent of 0.5 cm or more in the radial direction with respect to the longitudinal axis. As an alternative or in addition, the scraper element can be configured in the radial direction with respect to the longitudinal axis in such a manner that particles of dirt are conveyed by the scraper element out of the collection area of the collection container to the cover of the collection container when the scraper element is moved towards the second end side of the surface of the filter module or of the collection container.

It is thus possible to provide a scraper element, in particular a scraper ring, which creates a thorough cleaning of the filter module and of the collection area of the collection container.

The separator unit can also include a coupling element which is connected to the scraper element and is configured in such a manner that it can be connected in a releasable manner to a complementary coupling element of an actuating element (for a user of the suction apparatus) so that the scraper element can be moved by the actuating element, which is connected to the coupling element, (along the longitudinal axis) over the surface of the filter module. The coupling element can be configured to create the releasable connection to the complementary coupling element of the actuating element with the aid of a magnetic force and/or with the aid of a latching arrangement to the complementary coupling element of the actuating element and/or with the aid of a bayonet catch.

The provision of a coupling element for a releasably coupled actuating element for actuating the scraper element renders it possible to conveniently and thoroughly clean the separator unit.

At least one guide rail (running along the longitudinal axis) so as to guide the movement of the scraper element can be arranged on the inner side of the collection container facing the collection area. The scraper element can have a guide element, for example a sliding block, which interacts with the guide rail in order to guide the movement of the scraper element (along the longitudinal axis). It is thus possible to create a particularly reliable movement of the scraper element along the longitudinal axis and thus to create a particularly reliable cleaning of the separator unit.

As already mentioned above, the surface of the filter module can extend along the longitudinal axis from the first end side, which is facing the blower of the suction apparatus during the operation of the suction apparatus, up to the second end side which is facing the cover of the collection container.

The scraper element can be configured in such a manner that the scraper element can be moved, by way of the actuating element connected to the coupling element, along the longitudinal axis from a suction position, in which the scraper element is arranged on the first end side of the surface of the filter module, up to an end position, in which the scraper element is arranged on the second end side of the surface of the filter module. It is thus possible to create a movement along the entire surface of the filter module in order to render it possible to clean the separator unit particularly thoroughly.

The scraper element can be configured in such a manner that the front face of the scraper element facing the cover of the collection container protrudes at least in some areas beyond the second end side of the surface of the filter module to the cover of the connection container. The front side of the scraper element can run in an oblique manner with respect to the longitudinal axis, for example. A scraper element configured in this manner renders it possible to clean the filter module particularly thoroughly.

The coupling element of the separator unit can be configured in such a manner that it is possible, by way of the actuating element connected to the coupling element, to create a force in the first direction, in particular in the forward direction, (from the first end face to the second end face of the filter module), so that the scraper element is moved in the first direction (along the longitudinal axis) over the surface of the filter module. Furthermore, the coupling element of the separator unit can be configured in such a manner that it is possible by way of the actuating element connected to the coupling element to create a force in the opposite second direction, in particular in the backward direction (from the second end face to the first end face of the filter module) so that the scraper element is moved in the second direction over the surface of the filter module.

It is thus possible to create a coupling to the actuating element and the coupling renders it possible for the scraper element to be pushed (in the first direction) and pulled (in the second direction) by way of the actuating element. It is thus possible to clean the separator unit in a particularly convenient manner.

The coupling element of the separator unit can be configured in such a manner that it is possible by way of the actuating element connected to the coupling element to create a force with a movement value in the second direction, in particular in the backward direction, and as a result the scraper element is moved (in particular pulled) in the second direction over the surface of the filter module. Moreover, the coupling element of the separator unit can be configured in such a manner that it is possible by way of the actuating element connected to the coupling element to create a force with a decoupling value, which is greater than the movement value, in the second direction, in particular in the backward direction, and as a result the actuating element is released from the coupling element.

This thus enables a user to decouple the actuating element from the separator unit by suitably metering its force. It is thus possible to further increase the convenience of the separator unit.

In accordance with a further aspect, a further separator unit is described for a suction apparatus. It is to be noted that the features of a separator unit described in this document can be used individually and/or also in combination for this separator unit.

As already mentioned, the separator unit contains a collection container with a collection area for receiving particles from a suction airflow of the suction apparatus. Moreover, the separator unit contains a filter module which is arranged in the collection container and is configured to filter out particles from the suction airflow.

The surface of the (cylindrical) filter module can have at least one (guide) groove running along the longitudinal axis. As already mentioned above, the filter module can have a sieve with a support structure. The one or more (guide) grooves can be arranged in the support structure of the sieve. The one or more (guide) grooves can each extend from the first end side up to the second end side of the surface of the filter module.

Moreover, the separator unit contains a scraper element that is configured to be moved along the longitudinal axis over the surface of the filter module (for example by way of an actuating element), in order to clean the surface of the filter module. As already mentioned, the scraper element can comprise a scraper ring, in particular a scraper ring, which encompasses the outer surface of the filter module in the circumferential direction.

The scraper element can have at least one rib which during the movement of the scraper element along the longitudinal axis can engage in the corresponding groove in the surface of the filter module. The rib can be made to engage in the groove along the entire movement of the scraper element (in particular along the entire length of the filter module from the suction position up to the end position). The rib can be arranged on the inner side of the scraper element facing the filter module.

This thus describes a separator unit with a scraper element which has at least one rib which engages in a groove of the filter module. The scraper element can thus be moved in a particularly reliable manner. Moreover, it is possible in this way to remove hairs in a particularly reliable manner from the surface of the filter module.

The surface of the filter module can have multiple grooves which run along the longitudinal axis and are arranged distributed in particular uniformly at various sites along the circumferential direction of the surface of the filter module. In a corresponding manner, the scraper element can have multiple ribs for the multiple grooves. In this case, one rib can engage respectively (in a one-to-one relationship) into a corresponding groove.

The provision of multiple grooves and ribs can further improve the movement of the scraper element and the cleaning of the filter module.

The one or more ribs can each be configured on the front side facing the cover of the collection container as a blade, in particular as a blade for cutting hair. This can further improve the removal of hairs from the separator unit.

The separator unit can comprise an actuating element (which can be coupled in a detachable manner where appropriate) that is configured to act on the scraper element in order to move the scraper element along the longitudinal axis over the surface of the filter module. The actuating element can comprise a rod which extends along the longitudinal axis and has a grip, wherein the rod can be moved by way of the grip along the longitudinal axis in order to move the scraper element along the longitudinal axis (between the suction position and the end position) over the surface of the filter module. The provision of an actuating element can further increase the convenience of the separator unit.

The separator unit can have a connecting piece which extends away from the filter module along the longitudinal axis starting from the first end side of the filter module (which is facing the blower of the suction apparatus). The actuating element can be arranged in the connecting piece, in particular mounted in a movable manner. The scraper element can thus be moved in a particularly reliable manner so as to clean the separator unit.

The actuating element can be configured to be moved starting from a starting position along the first direction, in particular along the forward direction, in order to move the scraper element starting from the suction position along the first direction over the surface of the filter module.

Furthermore, the actuating element can contain a spring module, in particular a (restoring) spring that is configured to move the actuating element along the opposite, second direction, in particular along the backward direction, automatically back to the starting position in order to move the scraper element back into the suction position. This can be used to automatically return the scraper element. It is thus possible to further increase the convenience of the separator unit.

In accordance with a further aspect, a further separator unit is described for a suction apparatus. It is to be noted that the features of a separator unit described in this document can also be used individually and/or in combination for this separator unit.

The separator unit contains a collection container with a collection area for receiving particles (of dirt) from the suction airflow of the suction apparatus, wherein the collection container extends along the longitudinal axis from a first end side, which is facing the blower of the suction apparatus during the operation of the suction apparatus, up to a second end side, on which the cover of the collection container is arranged.

The separator unit also contains a filter module which is arranged on the collection container and is configured to filter out particles of dirt from the suction airflow. The filter module has a first end side on the first end side of the collection container. Moreover, the filter module has a second end side on the opposite second end side of the collection container.

The filter module can be designed to be removed from the collection container or inserted into the collection container on the first end face of the collection container. It can thus be rendered possible to remove the filter module from the collection container on the first end side remote from the cover of the collection container. This makes removal particularly convenient, in particular, without the user coming into contact with the dirt in the collection container.

The separator unit moreover contains a scraper element. The scraper element can be configured to slide over the surface of the filter module when the filter module is removed from the collection container on the first end side of the collection container. The scraper element can thus be configured to scrape or remove particles of dirt off the surface of the filter module when the filter module is removed from the collection container via the first end side of the collection container. Thus, the filter module can be removed in a particularly convenient manner.

The filter module can have a filter cover on the side (i.e. on the first end side of the filter module) facing the first end side of the collection container. The filter cover can be made from a hard material (for example from a duroplast or duromer). The filter cover can be configured as a grip which can be held by the user of the suction apparatus in order to remove (in particular to pull) the filter module from the collection container or to insert (in particular to push) the filter module into the collection container. Thus, the filter module can be removed in a particularly convenient manner.

The filter module can be configured, in particular by way of a mechanical position coding on the filter cover of the filter module, in such a manner that the filer module can only be arranged in a defined angular position with respect to the longitudinal axis in the collection container. Consequently, it is possible to avoid the filter module rotating about the longitudinal axis. The filter cover can have for example a circular contour with a flattened section. The mechanical position coding can be formed by the flattened section of the filter cover. The provision of a mechanical position coding of the filter module renders it possible to insert the filter module in a particularly convenient and reliable manner.

The cover can be mounted on the second end face of the collection container in a pivotable manner about the pivot axis via an articulated joint. In this case, the pivot axis can be compressed in the axial direction so that by compressing the pivot axis the cover can be released from the collection container or attached to the collection container. This enables the user to remove the cover when required, for example in order to be able to better clean the collection container.

As already mentioned further above, the scraper element can be configured to be moved along the longitudinal axis (toward the second end side of the collection container) over the surface of the filter module. The scraper element can be designed so as, when the cover of the collection container is closed, to be moved toward the second end side of the collection container in order to compress particles of dirt arranged in the collection area of the collection container. As an alternative or in addition, the scraper element can be configured so as, when the cover of the collection container is open, to be moved toward the second end side of the collection container in order to eject from the collection container particles of dirt arranged in the collection area of the collection container. The scraper element can thus provide a compression and/or ejection function. It is thus possible to operate a suction apparatus in a particularly convenient manner.

The separator unit can comprise a dedicated operating element for opening the cover, (which is arranged for example on the second end side of the collection container and/or on a side wall of the collection container). The operating element can enable the user to open the cover of the collection container when required. The separator unit can be configured in such a manner that the scraper element can be moved toward the second end side of the collection container without the cover of the collection container being (automatically) opened. It is thus possible to provide a particularly reliable compression function for compressing particles of dirt in the collection container.

The separator unit can comprise an actuating element that is configured to act on the scraper element in order to move the scraper element along the longitudinal axis toward the second end side of the collection container over the surface of the filter module. The actuating element can comprise a rod with a grip, wherein the rod can be moved along the longitudinal axis in order to move the scraper element along the longitudinal axis over the surface of the filter module. The rod can be fixedly attached to the scraper element (so that the scraper element can be pushed by the rod (toward the second end side of the collection container) and pulled (toward the first end side of the collection container). This renders it possible for the scraper element to be moved in a particularly reliable manner in order to compress and/or eject particles of dirt.

The separator unit can have a connecting piece which extends away from the collection container along the longitudinal axis starting from the first end side of the collection container. The actuating element can be arranged in and/or on the connecting piece. The connecting piece can be configured in such a manner that the connecting piece is arranged in a recess of the housing of the base part when the separator unit is connected to the base part. The provision of a connecting piece renders it possible to move the scraper element in a particularly reliably manner.

The collection container and/or the filter module can have a specific total length along the longitudinal axis (from the first end side up to the second end side). The connecting piece which protrudes beyond the first end side of the collection container can have a length which is 50% or more of the entire length of the collection container and/or of the filter module. It is thus possible to create a particularly reliable and complete scraping movement over the surface of the filter module.

The separator unit can have a restoring spring which is arranged at least in part in the connecting piece and is configured to move the actuating element and the scraper element (attached thereto) automatically away from the second end side of the collection container into a basic position. The scraper element can be arranged in the basic position on the first end side of the collection container or of the filter module. An automatic resetting of the scraper element renders it possible to compress and/or eject particles of dirt in a particularly convenient manner.

In accordance with a further aspect, a suction apparatus is described which comprises a separator unit described in this document. The suction apparatus also comprises a base unit with a blower which is designed to generate the suction airflow by way of the separator unit.

The suction apparatus can also comprise an actuating element. As already mentioned above, the actuating element can comprise a rod with a grip, wherein the rod can be moved along the longitudinal axis in order to move the scraper element of the separator unit (along the longitudinal axis).

The actuating element can have a coupling element for coupling the actuating element to the coupling element of the separator unit. The actuating element can be integrated into the base unit, for example. The suction apparatus can be designed in such a manner that the separator unit can be removed from the base unit. In this case, the actuating element can remain on the base unit when necessary. It can thus be rendered possible to handle the separator unit in a particularly convenient manner.

As an alternative or in addition, the separator unit can comprise an operating element which is configured in such a manner that the user can press the operating element (together), in particular with two fingers, in order in so doing (i.e. during the pressing) to hold the separator unit, and simultaneously (by way of the pressing) to release a locking mechanism with which the separator unit is attached to the base unit.

The operating element can be arranged on a side wall of the collection container which is remote from the base unit and the side wall runs between the first end side and the second end side of the collection container. The locking mechanism can be configured in such a manner that the separator unit can be dismantled from the base unit along a dismantling direction which runs (essentially or completely) perpendicular to the longitudinal axis of the separator unit. It is thus possible to dismantle or assemble the separator unit in a particularly convenient manner.

As already mentioned above, the actuating element can be configured to be moved, starting from a starting position along the first direction, in particular along the forward direction, in order to move the scraper element starting from the suction position along the first direction over the surface of the filter module.

Furthermore, the actuating element can contain a spring module, in particular a (restoring) spring that is designed to move the actuating element along the opposite, second direction, in particular along the backward direction, automatically back to the starting position, in order to move the scraper element back into the suction position. This can be used to automatically return the scraper element. The convenience of the suction apparatus can thus be further increased.

It is to be noted that each aspect of the separator units and/or suction apparatuses described in this document can be combined with one another in numerous ways. In particular, the features of the claims can be combined with one another in numerous ways.

Other features which are considered as characteristic for the invention are set forth in the appended claims.

Although the invention is illustrated and described herein as embodied in a separator unit with an ejection and/or compression function, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A is a diagrammatic, perspective view of an exemplary suction apparatus with a separator unit which has a scraper ring;

FIG. 1B is a perspective view of the suction apparatus from FIG. 1A with an actuating rod coupled to the scraper ring;

FIG. 1C is a perspective view of the suction apparatus from FIG. 1A wherein the scraper ring is arranged in a scraper position;

FIG. 2A is a perspective view of the suction apparatus from FIG. 1A;

FIG. 2B is a perspective view of the suction apparatus from FIG. 2A with a rod coupled thereto;

FIG. 2C is a perspective view of the suction apparatus from FIG. 2A, wherein the scraper ring is arranged in a scraper position;

FIG. 3A is a perspective view of the suction apparatus from FIG. 1A with a decoupled separator unit;

FIG. 3B is a perspective view of the suction apparatus from FIG. 3A;

FIG. 4A is a perspective view of the suction apparatus with the scraper ring which has one or more scraper ribs;

FIG. 4B is a perspective view of the suction apparatus from FIG. 4A, wherein the scraper ring is arranged in the end position;

FIG. 5A is a perspective view of an exemplary separator unit, wherein the scraper ring is arranged in the suction position;

FIG. 5B is a perspective view of the separator unit from FIG. 5A, wherein the scraper ring is arranged in the end position;

FIG. 6 is a perspective view of the separator unit from FIG. 5A;

FIG. 7A is a side view of the separator unit from FIG. 5A;

FIG. 7B is a cross-sectional view of the separator unit from FIG. 7A;

FIG. 7C is a sectional view of a detail shown in FIG. 7B; and

FIGS. 8A and 8b are sectional views of the separator unit with various positions of the scraper element.

### DETAILED DESCRIPTION OF THE INVENTION

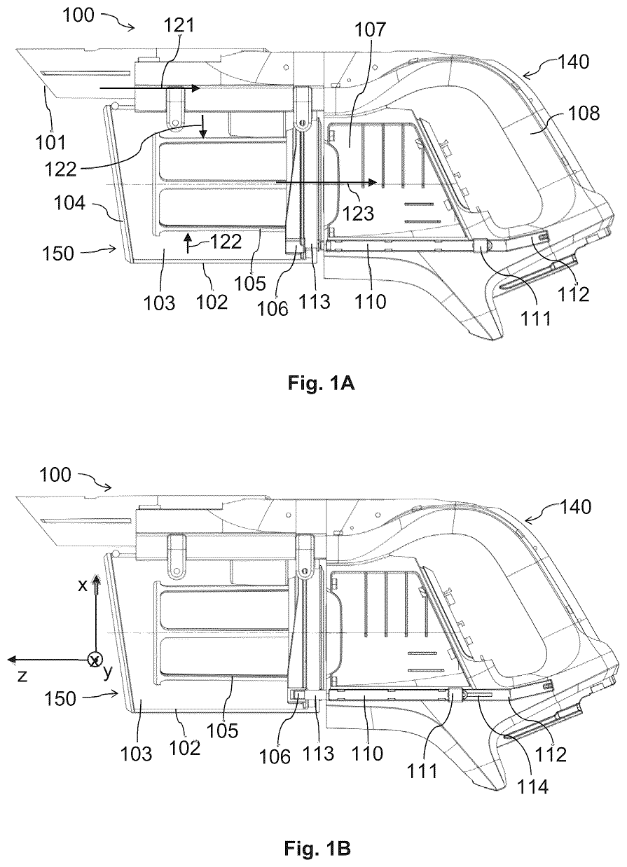

As mentioned in the introduction, the present document is concerned with rendering it possible to clean the separator unit of a suction apparatus in a particularly convenient and reliable manner. In this context, FIG. 1A shows an exemplary suction apparatus 100, in particular a hand-held vacuum cleaner, with a separator unit 150. The separator unit 150 contains a, where appropriate cylindrical, collection container 102 with a cover 104 which is arranged, for example, on an end face or end side of the collection container 102 and can be opened in order to empty the collection container 102. A filter module 105 is typically arranged in the center of the collection container 102 and the filter module is configured to separate particles of dirt and/or dust from the suction airflow 121, 122, 123 of the suction apparatus 100. The filter module 105 can be cylindrical. The particles of dirt and/or dust can be collected in an annular collection area 103 of the collection container 102 around the filter module 105.

The suction apparatus 100 contains a blower 107 which is configured to create the suction airflow 121, 122, 123 by way of the suction apparatus 100, in particular by way of the separator unit 150. The suction airflow 121 flows via the suction mouth 101 of the suction apparatus 100 into the collection container 102, in particular into the collection area 103 of the collection container 102. The suction airflow 122 is guided, in particular sucked, in the collection container 102 by way of the filter module 105, so that the particles of dirt and/or dust are separated from the suction airflow 122 and collected in the collection area 103. After flowing through the filter module 105, the suction airflow 123 flows to the blower 107 and is blown out of the suction apparatus 100 there.

As mentioned in the introduction, the emptying and/or cleaning of the separator unit 150 can be perceived by a user of the suction apparatus 100 as inconvenient. By way of example, it can be necessary to place the suction apparatus 100 with the cover 104 of the collection container 102 open over a garbage can and to shake it in order to convey the dirt and dust out of the collection area 103. Moreover, it can possibly be necessary to remove the filter module 105 from the collection container 105 by hand.

The suction apparatus 100 illustrated in FIG. 1A contains a scraper ring 106 (in general a scraper element) which is arranged around the (cylindrical) filter module 105. The scraper ring 106 can be arranged in such a manner as to be able to move on the filter module 105 that the scraper ring 106 can be moved along the longitudinal or vertical axis of the filter module 105 in order to clean the surface of the filter module 105. The filter module 105 can have a first end face or end side which is facing the blower 107 and a second end face or end side which is facing the cover 104 of the collection container 102. The scraper ring 106 can be designed to be moved along the longitudinal axis from a suction position (on the first end face of the filter module 105) up to an end position (on the second end face of the filter module 105).

During the movement of the scraper ring 106 from the suction position up to the end position, the scraper ring 106 acts on the surface of the filter module 105 in a mechanical manner and in so doing removes particles of dirt and/or dust from the surface of the filter module 105. This renders it possible to clean the filter module in a convenient manner.

The scraper ring 106 can have a specific spatial spread in the radial direction (radially with respect to the longitudinal axis). Where appropriate, the scraper ring 106 can extend in the radial direction from the surface of the filter module 105 up to the inner side of the wall of the collection container 102. In other words, the scraper ring 106 can extend, where appropriate, over the entire (annular) cross-section of the collection area 103. It is thus possible for the movement of the scraper ring 106 from the suction position up to the end position to cause the dirt and dust arranged in the collection area 103 to be conveyed to the cover 104 of the collection container 102 and out of the collection container 102. It is thus possible to thoroughly empty the collection container 102.

The blower 107 and the suction mouth 101 can be arranged on a base unit 140 of the suction apparatus 100. The base unit 140 can also have a grip 108 which enables the user to hold the suction apparatus 100 (with one hand). The grip 108 can be arranged with respect to the flow direction of the suction airflow 123 downstream or upstream with respect to the blower 107. The grip 107 and the suction mouth 101 can be formed by a blower of the base unit 140 of the suction apparatus 100.

The suction apparatus 100, in particular the separator unit 150 contains a rod 110 which can be used to move the scraper ring 106. The rod 110 can be arranged along the longitudinal axis and/or with respect to the flow direction of the suction airflow 123 downstream of the scraper ring 106 so that the scraper ring 106 can be pushed by the rod 110 from the suction position to the end position. The rod 110 can be arranged, as illustrated by way of example in FIG. 1A, in a guide 112, for example in a guide channel, on the housing of the suction apparatus 100, in particular the base unit 140 of the suction apparatus 100. Moreover, a grip 111 can be arranged on the rod 110 and the grip enables a user to act on the rod 110 in order to move the rod 110 along the longitudinal axis and in order thus to cause the scraper ring 106 to move from the suction position up to the end position. The rod 110 and/or the grip 111 can be referred to in general as an actuating element.

The rod 110 can be connected and/or coupled via a coupling 113, preferably one that can be decoupled, to the scraper ring 106. The provision of a coupling 113 renders it possible to decouple the separator unit 150 from the suction apparatus 100 and in so doing to leave the rod 110 (within the guide 112) on the base unit 140 of the suction apparatus 100. The coupling 113 can have a mechanical and/or a magnetic coupling mechanism, for example.

FIG. 1A shows the coupling 113 in an open state so that the rod 110 and the scraper ring 106 are decoupled from each other. FIG. 1B shows the coupling 113 in a closed state so that the rod 110 is coupled to the scraper ring 106 and can thus cause the scraper ring 106 to move along the longitudinal axis. FIG. 1C shows the scraper ring 106 in a scraper position between the suction position and the end position. Moreover, FIG. 1C illustrates how, by pushing the rod 110 forward (toward the cover 104 of the collection container 102), the scraper ring 106 can be moved from the suction position to the end position. It is to be noted that in FIG. 1C the scraper ring 106 is illustrated in addition in the original suction position.

The coupling 113 is preferably configured in such a manner that the scraper ring 106 can be moved via the rod 110 back to the suction position. The coupling 113 can consequently also be designed for pulling forces along the longitudinal axis. The pulling forces that can be absorbed can be sufficiently high in order to be able to pull the scraper ring 106 up to the suction position with the aid of the rod 110. Moreover, the pulling forces that can be absorbed can be sufficiently low in order to enable the user to decouple the rod 110 from the scraper ring 106 by way of a continuous movement of the rod 110 beyond the suction position.

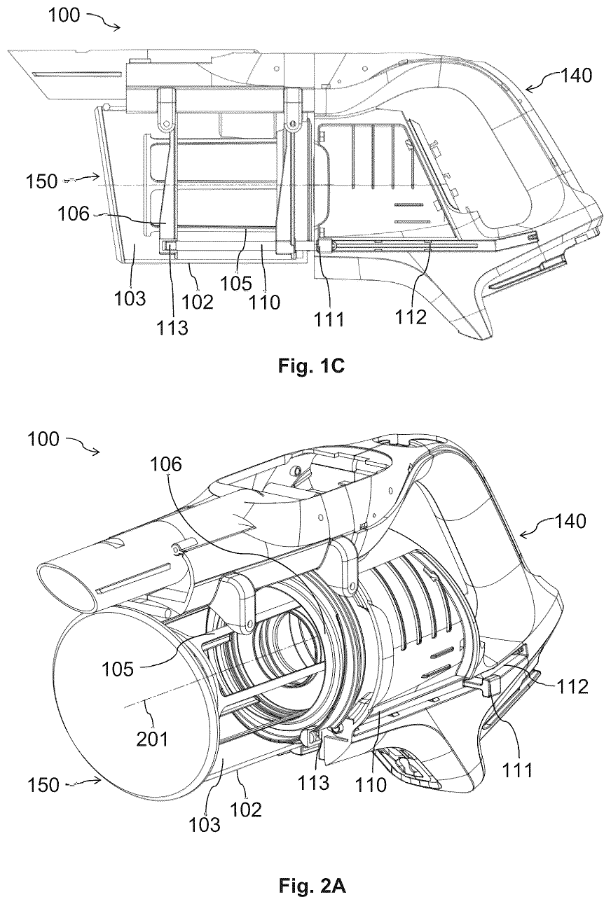

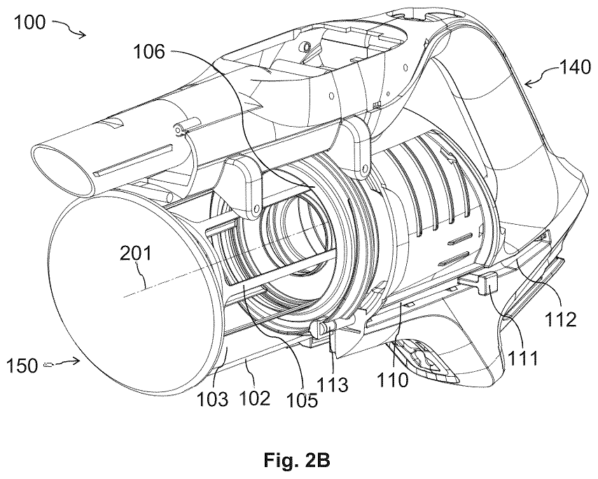

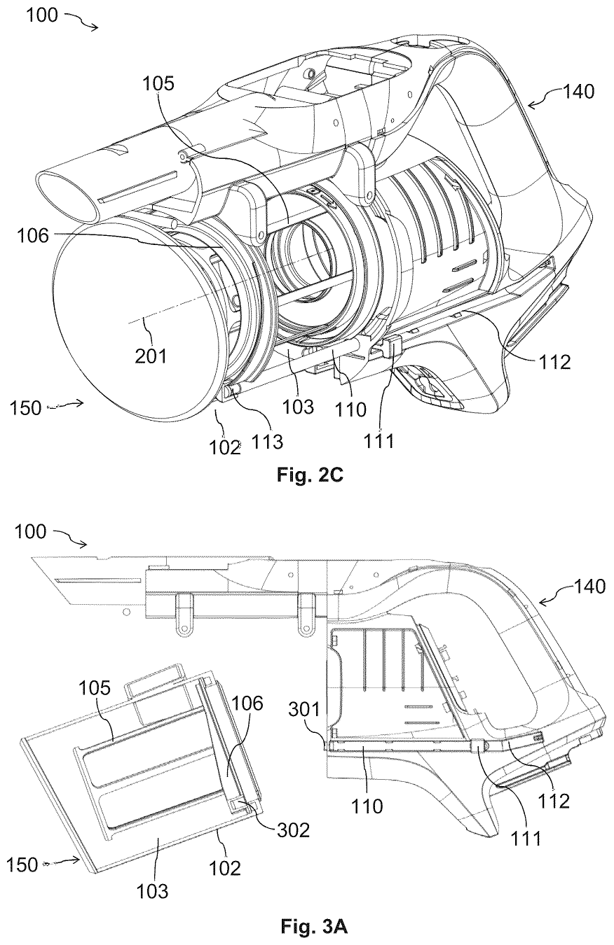

FIGS. 2A to 2C show perspective views of the suction apparatus 110 with an open coupling 113 (FIG. 2A), with a closed coupling 113 and with the scraper ring 106 in the suction position (FIG. 2B) and with the scraper ring 106 in a scraper position (between the suction position and the end position).

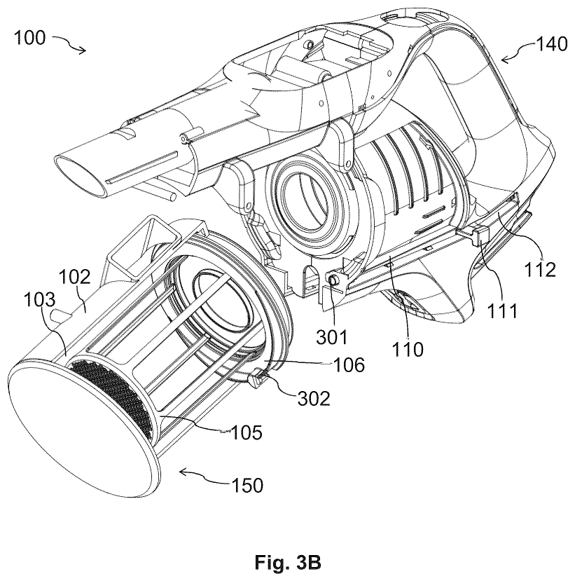

FIGS. 3A and 3B illustrate how the scraper unit 150 can be separated from the base unit 140 of the suction apparatus 100. A first coupling element 301 of the coupling 113 can be arranged on the rod 110. Moreover, a second coupling element 302 of the coupling 113 can be arranged on the scraper ring 106. The two coupling elements 301, 302 can be connected to each other in order to close the coupling 113. Moreover, the two coupling elements 301, 302 can be separated from each other in order to open the coupling 113. The two coupling elements 301, 302 can each comprise a (permanent) magnet. As an alternative or in addition, the two coupling elements 301, 302 can be configured to be mechanically complementary to each other in such a manner that a (releasable) latching connection can be formed by the two coupling elements 301, 302.

As is apparent from FIG. 1A, for example, the scraper ring 106 can be designed in such a manner that the front side of the scraper ring 106 facing the cover 104 of the collection container 102 runs in an oblique manner (with respect to the longitudinal axis 201). On the other hand, the rear side of the scraper ring 106 remote from the cover 104 runs perpendicular to the longitudinal axis 201. This renders possible an end position of the scraper ring 106, wherein the front side of the scraper ring 106 protrudes along the longitudinal axis at least in part over the outer surface of the filter module 105, whereas the rear side of the scraper ring 106 is still arranged on the outer surface of the filter module 105. The outer surface of the filter module 105 can thus be cleaned particularly reliably. Moreover, the dirt in the collection area 103 of the collection container 102 can be pushed in a particularly reliable manner out of the collection container 102.

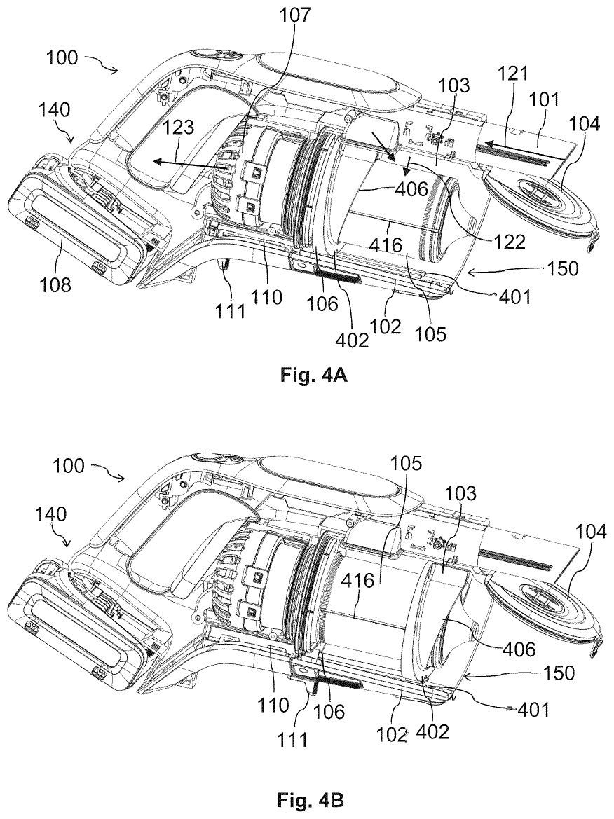

The obliquely running front side 406 of the scraper ring 106 is particularly clearly apparent in FIG. 4A. Moreover, FIG. 4B shows the scraper ring 106 in the end position, and it is apparent that the front side 406 of the scraper ring 106 at least partially extends beyond the outer surface of the filter module 105.

In the case of the suction apparatus 100 illustrated in FIGS. 4A and 4B, the rod 110 is arranged in a lower area of the housing of the base unit 140 so as to actuate (in particular to move) the scraper ring 106. Moreover, a guide rail 401 (for example in the form of a groove) is arranged on the inner side of the wall of the collection container 102 so as to guide the scraper ring 106. The scraper ring 106 has a guide element 402 (for example a sliding block) by way of which the scraper ring 106 can be moved along the guide rail 401 between the suction position and the end position. The provision of a guide rail 401 can increase the reliability of the movement of the scraper ring 106.

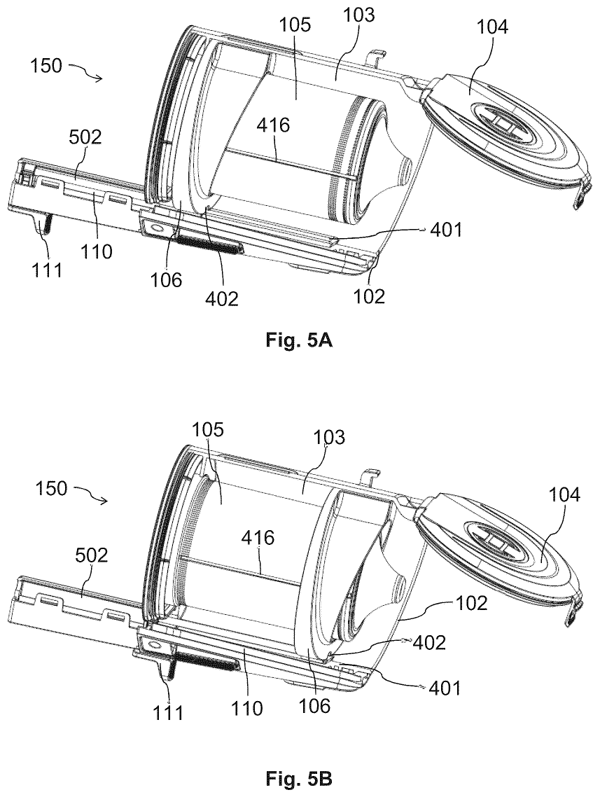

FIGS. 5A and 5B illustrate the separator unit 150 which is decoupled and/or removed from the base unit 140 of the suction apparatus 100. The scraper ring 106 is shown in the suction position (for the suction operation) in FIG. 5A and the scraper ring 106 is shown in the end position (for cleaning the separator unit 150) in FIG. 5B.

The separator unit 150 has a connecting piece 502 which extends along the longitudinal axis 201 away from the first end face or end side of the collection container 102. The rod 110 and the rod grip 111 for actuating (in particular for causing a movement of) the scraper ring 106 are arranged in the connecting piece 502. The connecting piece 502 can have a length along the longitudinal axis 201 that is such a size that the scraper ring 106 can be pushed over the entire length of the outer surface of the filter module 105 by pushing the rod grip 111. The base unit 140 can have a recess for receiving the connecting piece 502 of the separator unit 150.

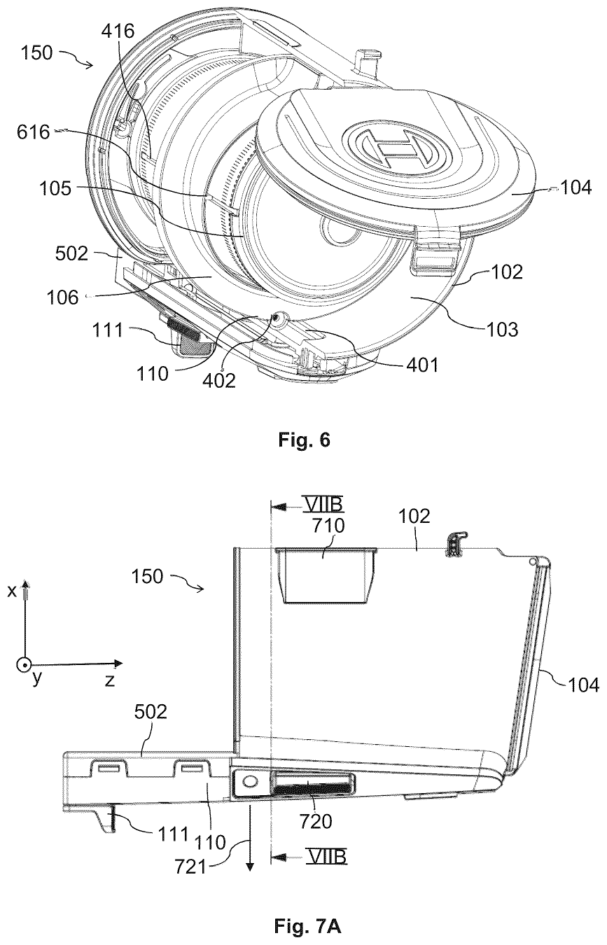

FIG. 6 shows the separator unit 150 from FIGS. 5A and 5B in a perspective view.

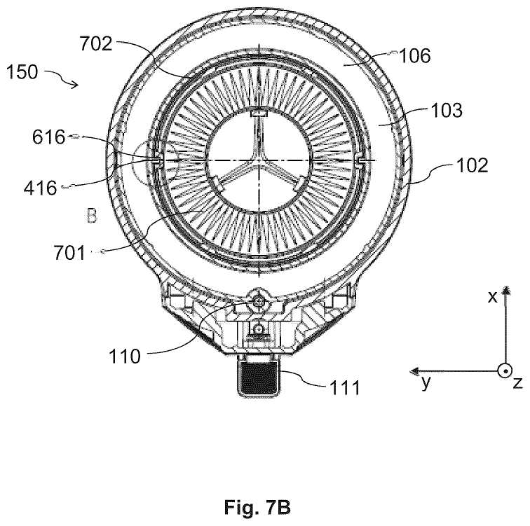

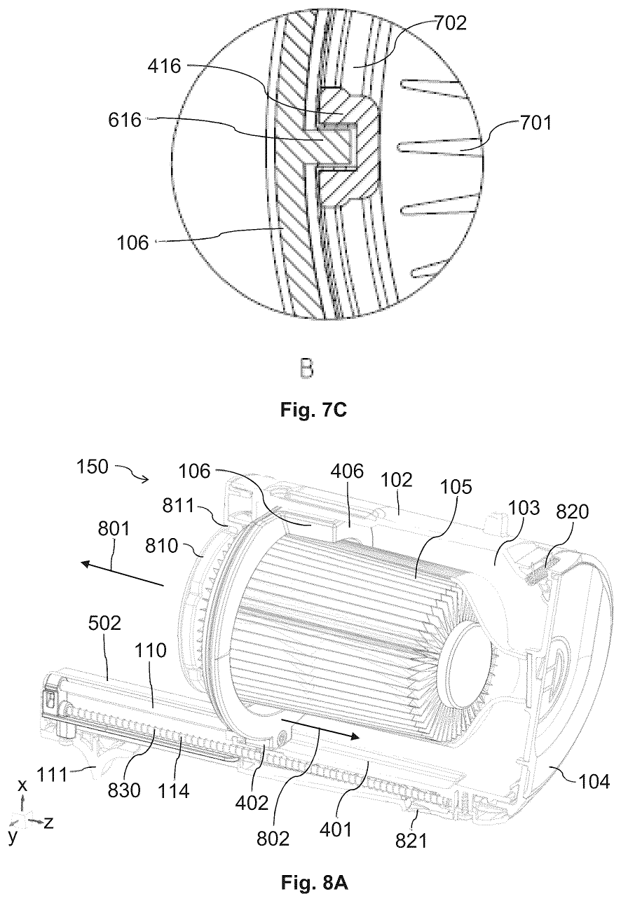

The filter module 105 can have at least one groove 416 which is arranged on the outer surface of the filter module 105 and runs along the longitudinal axis 201 between the first and the second end face or end side of the filter module 105. Furthermore, the scraper ring 106 can have on the inner side facing the outer surface of the filter module 105 at least one rib 616 which engages in the groove 416 of the outer surface of the filter module 105 (see FIG. 6 and FIGS. 7A, 7B and 7C).

By way of the rib 616 which engages in the groove 416, hairs and/or threads which have wrapped around the outer surface of the filter module 105 are pushed reliably off the outer surface of the filter module 105 when the scraper ring 106 is moved from the suction position to the end position. The hairs and/or threads which have been scraped off are pushed in particular toward the first end face of the filter module 105 and pushed beyond the first end face through the cover 104 out of the collection container 102. It is thus possible to clean the filter module 105 in a particularly convenient manner.

FIG. 7B shows a sectional view through the collection container 102 and through the filter module 105 along the interface VIIB-VIIB which is illustrated in FIG. 7A and is arranged perpendicular to the longitudinal axis 201. The filter module 105 comprises in the illustrated example a cylindrical sieve 702 (which is also referred to as a lint filter). The sieve 702 encompasses a fan-shaped dust filter 701. It is possible to arrange in the outer surface of the sieve 702, in particular in the support structure of the sieve 702, one or more grooves 416, which each run along the longitudinal axis 201. It is possible to arrange on the inner side of the scraper ring 106 one or more corresponding ribs 616, which engage in the corresponding one or more grooves 416.

In this document, an ejector mechanism for ejecting dirt from the collection container 102 is described, by way of which it is possible to remove the collection container 102 and the filter module 105 from the suction apparatus 110, in particular from the base unit 140 of the suction apparatus 100. For this purpose, the ejector rod 110 can be released and/or decoupled and/or uncoupled from the ejector- and/or scraper ring 106. The ejector rod 110 can be integrated and/or movably mounted in the base unit 140 of the suction apparatus 100.

It is possible to arrange at the rear end of the ejector rod 110 (wherein the rear end is remote from the collection container 102), a grip 111 which enables a user to push the rod 110 forward (toward the collection container 102). The rod 110 can be held by means of a (restoring) spring 114 (see FIG. 1B) in its starting position (wherein the starting position of the rod 110 corresponds to the suction position of the scraper ring 106). The spring 114 can be configured to automatically bring the rod 110 back into its starting position after the ejector mechanism has been actuated.

By actuating the rod 110 (i.e. by pushing the rod 110 forward) it is possible, where appropriate, to open a cover of the filter module 105 and/or of the collection container 102, and the rod 110 can thus be coupled to the ejector- and/or scraper ring 106 via a coupling 113 (for example by means of a magnet, a bayonet catch and/or a latching arrangement). By pushing the rod 110 and ejector- and/or scraper ring 106 (i.e. the ejector mechanism) further forward, the dirt in the collection area 103 of the collection container 102 is pushed forward and out of the open cover flap 104 of the collection container 102. Simultaneously, the lint filter 702 of the filter module 105 is cleaned so that it is not necessary to subsequently remove hairs or other dirt.

If the grip 111 of the ejector rod 110 is released, the ejector rod 110 moves back into its starting position as a result of the restoring force of the spring 114 and in so doing moves the ejector- and/or scraper ring 106 back into the suction position. The ejector rod 110 subsequently decouples itself, where appropriate, from the ejector- and/or scraper ring 106 so that the collection container 102 can be removed from the base unit 140 when required (and the rod 110 remains on the base unit).

The speed of the emptying process can be regulated in such a manner that the user can minimize the amount of a dust cloud created. In so doing, the emptying process is performed while the collection container 102 is arranged on the suction apparatus 100. On the other hand, it is possible by uncoupling the ejector rod 110 to release the collection container 102 from the suction apparatus 100 when required. In this case, it is possible to remove the filter module 105 in a hygienic manner since the filter module 105 can be pulled out from behind (i.e. via the dust-free area). The filter module 105 can thus be maintained in a simple manner.

It is consequently possible to improve the handling during a process of emptying a removable (centrifugal- and/or cyclone-based) collection container 102. For this purpose, a compressing element, scraper element and/or ejecting element 106 is provided for the dust that has collected within the collection container 102. In this case, the ejector rod 110 can be decoupled and/or uncoupled between the manual handle (for example the grip 111) of the rod 110 and the scraper ring 106 of the collection container 102.

It is possible in the operating or suction position to separate the handle or the actuating element 110, 111 from the compressing element, scraper element or ejecting element 106. The handle or the actuating element 110, 111 can be coupled, where appropriate, first in a compressing, scraping or ejecting process to the compressing element, scraper element or ejecting element 106. As a result, when the dust separator unit 150 is in a removal position, the handle or the actuating element 110, 111 can remain in the base body 140 of the suction apparatus 100 so that during an emptying process a free-standing element does not obstruct the handling of the dust separator unit 150. In particular, this means that the dust separator unit 150 which has been removed does not have a protruding operating element 110, 111.

A bagless dust separator unit 150 is thus described which has a scraper element 106 for cleaning a cylindrical filter module 105. The scraper element 106 can be moved by way of an actuating element 110, 111, wherein the actuating element 110, 112 can be coupled to the scraper element 106 or decoupled therefrom. The coupling site or coupling 112 can be arranged at the transition from the dust separator unit 150 to the base device 140 so that there is no protrusion at the dust separator unit 150.

The scraper ring 106 can have one or more ribs 616 which protrude into the lint filter 702. It is thus possible to provide a reliable (longitudinal) guide for the scraper ring 106. Moreover, the one or more ribs 616 can ensure that hairs are scraped off. It is thus possible for hairs to be removed from the filter unit 106 while simultaneously guiding the scraper element 106. In other words, it is possible to provide a non-rotating arrangement, (in particular an arrangement which cannot rotate about the longitudinal axis), of a scraper ring 106 for cleaning a cylindrical filter module 105, in particular a lint filter 702.

For this purpose, at least one guide groove 416 can be provided on the cylindrical filter 105 of the separator unit 150. As a result, a rotational movement between the scraper element 106 and the filter 105 is reliably prevented. The actuating element 110, 111 for the scraper element 105 can be arranged off-center and/or in an axially moveable manner. The scraper ring 106 can have at least one rib 616 which engages in the groove 416 on the filter 105. This groove 416 ensures that the scraper ring 106 is reliably guided during a cleaning process. Moreover, it is possible to reliably remove dirt particles deposited on the filter 105 and/or hairs wrapped around the filter, which can be completely scrapped off in the collection area 103 of the collection container 102.

The filter module 105 has (on the end side facing the cover 104) preferably a free filter end so that the hairs which have been scraped can fall off the filter module 105.

It is possible to arrange a blade on the slider or on the rib 616 so as to cut through the hairs. In particular, a rib 616 can be in the form of a blade. It is thus possible to cut through wrapped-around hairs during the movement of the scraper ring 106 and remove them with increased reliability from the filter module 105. Moreover, it is possible to avoid the wrapped-around hairs becoming tightened so that the necessary force to displace the scraper ring 106 can be reduced.

Multiple grooves 416 can be formed on the circumference of the filter module 105. Moreover, the scraper ring 106 can have multiple ribs 616. This can further improve the guidance of the scraper ring 106. In particular, it is possible to reliably avoid the scraper ring 106 tilting.

A separator unit 150 is thus described which has within the collection container 102 a scraper ring (i.e. in general a scraper element) 106 which encompasses the filter module which is arranged in the collection container 102. The scraper ring 106 can be used so as to compress the dirt which is arranged in the collection area 103 of the collection container 102. For this purpose, the scraper ring 106 can be moved toward the cover 104 of the collection container 102 (while the cover 104 is closed). Moreover, the scraper ring 106 can be used so as (when the cover 104 is open) to eject the dirt from the collection area 103 of the collection container 102. The scraper ring or the scraper element 106 can therefore also be described as a compressing and/or ejecting element.

A Cartesian coordinate system is partially illustrated in the figures in order to illustrate the spatial orientation of the different views. In this case, the z-axis of the coordinate system corresponds to the longitudinal axis 201 of the suction apparatus 100. The x-axis of the coordinate system can correspond to the vertical axis of the suction apparatus 100 which extends from the lower area of the suction apparatus 100 or of the separator unit 150 (in which, for example, the connecting piece 502 and/or the grip 111 are arranged) up to the upper area of the suction apparatus 100 or of the separator unit 150 (in which, for example, the suction mouth 101 of the suction apparatus 100 and/or the suction mouth opening 710 of the collection container of the separator unit 150 are arranged). The plane formed by the x-axis and the z-axis can represent a symmetry plane of the suction apparatus 100 and/or of the separator unit 150. The y-axis can correspond to the transverse axis of the suction apparatus 100 which extends from the right-hand side up to the left-hand side of the suction apparatus 100 when the suction apparatus 100 is held by a user holding the grip 108 of the suction apparatus 100.

It is possible to arrange an operating element 720 on the separator unit 150, in particular in the lower area of the separator unit 150 in which the connecting piece 502 is also arranged with the grip 111 for moving the scraper element 106 (see FIG. 7A) and the operating element 710 can be actuated, in particular pressed, by a user in order to release a locking mechanism. In this case, the locking mechanism can be designed in such a manner that the separator unit 150 can be moved away from the base unit 140 of the suction apparatus 100 along the dismantling direction 721, illustrated in FIG. 7A, in order to remove and/or separate the separator unit 150 from the base unit 140. The dismantling direction 721 can run essentially parallel to the x-axis. It is thus possible to dismantle the separator unit 150 in a particularly convenient manner. The separator unit 150 can be mounted precisely in the opposite direction.

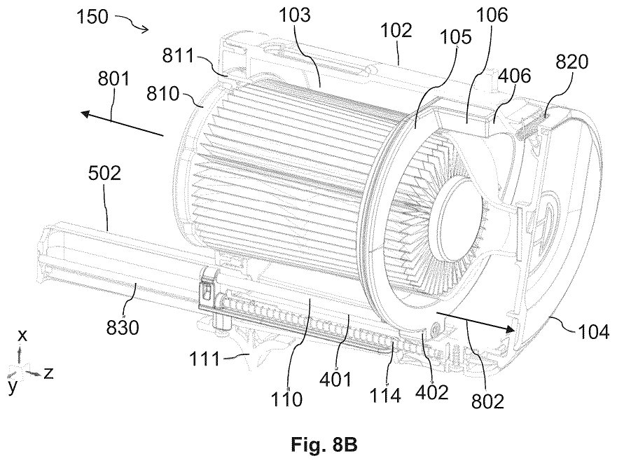

FIGS. 8A and 8B each show a perspective sectional view of the separator unit 150. The section plane corresponds to the (symmetry) plane that is formed by the x-axis and the z-axis. FIG. 8A shows a basic state in which the scraper element 106 is arranged on the first (remote from the cover 104) end side of the filter module 105 and FIG. 8A shows a state in which the scraper element 106 is arranged on the opposite second (facing the cover 104) end side of the filter module 105. The grip 111 for moving the scraper element 106 is arranged in FIG. 8A on the end of the connecting piece 502 remote from the cover 104. The spring module 114, which has for example a compression spring which is arranged around a spring rod 830, is designed to push the grip 111 away from the cover 104 so that the grip 111 is held on the end of the connecting piece 502 remote from the cover 104 (i.e. in the basic state).

If the user moves the grip 111 along the connecting piece 502 towards the cover 104, the compression spring of the spring module 114 is compressed. Moreover, the scraper element 106 is moved by way of the guide 112 along the compressing and/or ejecting direction 802 illustrated in FIG. 8A in order to compress and/or eject the dirt in the collection area 103 (see FIG. 8B). When the user releases the grip 111, the grip 111 and the scraper element 106 are moved by way of the spring module 114 back into the basic position (i.e. into the basic state) illustrated in FIG. 8A.

The filter module 105 can have a filter cover 810 on the end remote from the cover 104 and the filter cover is preferably essentially non-deformable so that the filter cover 810 can be grasped by a user with one hand in order to remove the filter module 105 along the removal direction 801 from the collection container 102 of the separator unit 150. The removal direction 801 can run parallel to the longitudinal axis 201 or the z-axis. The separator unit 150 can thus be designed in such a manner that the filter module 105 can be removed from the collection container 102 on the end side remote from the cover 104. The user can thus be reliably prevented during the removal from coming into contact with dirt from the collection container 102. Moreover, it is possible by way of removing the filter module 105 along the removal direction 801 for the surface of the filter module 105 during the removal to be scraped by the scraper element 105 and consequently cleaned. This makes the removal particularly convenient.

The filter cover 810 can have a flattened area 811 which can be used as a mechanical position coding. In particular, the flattened area 811 can be configured in such a manner that the filter cover 810 can be arranged only in a single angular position (with respect to a rotation about the longitudinal axis 201) within the collection container 102. It is thus possible to further increase the convenience of the separator unit 105 with respect to the removal and insertion of the filter module 105.

The cover 104 arranged on the second end side of the collection container 102 can be pivotably attached to the collection container 102 via an articulated joint 820. It is possible to arrange on the articulated joint a restoring spring (for example a torsion spring) which is designed to automatically push the cover 104 into the open state (as soon as the latching element of the cover 104 has been released). The restoring spring can be arranged about a pivot axis of the articulated joint 820. The pivot axis can be designed to be compressed along the axial direction so that the pivot axis can be pushed out of by way of compressing the articulated joint 820 out of the bearings. The provision of an articulated joint 820 with a pivot axis which can be compressed in the axial direction enables the user to remove the cover 104 from the collection container 102 or to attach it to the collection container 102 in a convenient manner. The process of emptying the collection container 102 can thus be further simplified.

The separator unit 150 can have a dedicated operating element 821 which can be actuated by the user in order to open the cover 104 of the collection container 102 (in particular in order to release the latching element). The operating element 821 can be configured to move a latching element (not illustrated) in order to free the cover 104. The latching element can be arranged opposite the articulated joint 820 of the cover 104. The provision of a dedicated operating element 821 for opening the cover 104 enables the user to move the scraper element 106 within the collection container 102 when the cover 104 is closed in order to compress the dirt within the collection container 102, without emptying the collection container 102. After the compressing is complete, the suction apparatus 100 can be operated again with increased suction power.

A separator unit 150 is consequently described which has a grip 111 or a lever which can be pushed on a guide rod 830 along the longitudinal axis 201 and/or in a compressing and/or ejecting direction 802. A compression spring 114 is arranged between the grip 111 and the guide rod 830 and the compression spring restores the guide and consequently the entire mechanism back into the basic position (i.e. in the basic position). A second axis or rod 110 which penetrates the collection container 102 is located on the inner side (facing the base part 104 or the collection container 102). This axis or rod 110 is fixedly connected to the scraper element 106 which pushes the dirt out of the collection container 102 or compresses it in the collection container 102.

In order to remove the filter module 105 from the collection container 102, the separator unit can be initially separated from the base unit 140 of the suction apparatus 100. Subsequently, the filter module 105 can be pulled along the removal direction 801.

The measures described in this document render it possible to separate the separator unit 150 from the base unit 140 in order to be able to empty the collection container 102 in a convenient manner. The filter module 105 can be removed from the collection container 102 in a convenient manner. In so doing, the (clean) filter cover 810 can be used as a gripping surface. It is not necessary to grip the dirty filter material or to use a special tool.

The dismantling the separator unit 105 with the collection container 102 provides easy access to the suction mouth opening 710 (i.e. the inlet area) of the collection container 102 and it can therefore be cleaned in a convenient manner (for example in order to eliminate a blockage).

The dismantling of the separator unit 105 and the removal of the filter module 105 render it possible in a convenient manner to remove dirt downstream of the scraper element 106 (without having to reach into the collection container 102 by hand).

The removal of the filter module 105 along the removal direction 801 represents a further possibility for the scraper element 106 to scrape the filter module 105, for example when the grip 111 can no longer be moved due to a collection container 102 being too full.

Measures are thus described which render it possible to compress and/or completely eject dust from a collection container 102 which has been removed. In particular, a removable separator unit 150 (with a collection container 102) for a vacuum cleaner 100 is described, wherein the dust can be emptied through a (lower) flap 104, wherein an annular element 106 is provided which can be moved along the filter 105 downward (during an emptying process) in order to clean the filter 105 and to eject the dust from the collection container 102. The filter 105 itself can be pulled out upward (in the opposite direction) during an emptying process) out of the collection container 102 in order to replace the filter or to clean it by hand.

A rigid connection is provided between the actuating element 110, 111 and the scraper ring 106.

Dust can be compressed or ejected during the normal operation in the case of the collection container 102 arranged on the base part 140 (without having to remove the collection container 102). On the other hand, the collection container 102 can be removed from the base part 140 first in order to subsequently compress or eject the dust.

The present invention is not limited to the illustrated exemplary embodiments. It is to be especially noted that the description and the figures are only intended to illustrate the principle of the proposed separator units 150 and/or suction apparatuses 100.

The following is a summary list of reference numerals and the corresponding structure used in the above description of the invention:

| | |
|---|---|
| 100 | Suction apparatus |
| 101 | Suction mouth |
| 102 | Collection container |
| 103 | Collection area |
| 104 | Cover (flap) |
| 105 | Filter module |
| 106 | Scraper element (scraper ring) |
| 107 | Blower |
| 108 | Grip |
| 110 | Rod |
| 111 | Grip |
| 112 | Guide (rod) |
| 113 | Coupling |
| 114 | Spring module (spring) |
| 140 | Base unit |
| 150 | Separator unit |
| 201 | Longitudinal axis |
| 301, 302 | Coupling element |
| 401 | Guide rail |
| 402 | Guide element |
| 406 | Front side (scraper element) |
| 416 | Guide groove |
| 502 | Connecting piece |
| 616 | Rib |
| 701 | Dust filter |
| 702 | Sieve (lint filter) |
| 710 | Suction mouth opening |
| 720 | Operating element (separator unit) |
| 721 | Dismantling direction (separator unit) |
| 801 | Removal direction (filter module) |
| 802 | Ejecting and/or compressing direction |
| 810 | Filter cover (gripping ring) |
| 811 | Flattened area of the gripping ring (mechanical |
| | position coding) |
| 820 | Articulated joint (cover) |
| 821 | Operating element (cover) |
| 830 | Spring rod |

1. A separator unit for a suction apparatus, the separator unit comprising:
a collection container with a collection area for receiving particles of dirt from a suction airflow of the suction apparatus, wherein said collection container extends along a longitudinal axis from a first end side, which during an operation of the suction apparatus faces a blower of the suction apparatus, up to a second end side on which a cover of said collection container is disposed;
a filter module disposed in said collection container and configured to filter the particles of dirt out of the suction airflow, wherein said collection area is adjacent to a surface of said filter module, wherein said filter module is configured so as on said first end side of said collection container to be removed from said collection container or to be inserted into said collection container; and
a scraper element configured so as to slide over said surface of said filter module when said filter module on said first end side of said collection container is removed from said collection container.

2. The separator unit according to claim 1, wherein:
said filter module has a filter cover on a side facing said first end side of said collection container; and
said filter cover is configured as a grip which is held by a user in order to remove said filter module from said collection container or to insert said filter module in said collection container.

3. The separator unit according to claim 2, wherein said filter module is configured by a mechanical position coding on said filter cover of said filter module in such a manner that said filter module can only be disposed in said collection container in a defined angular position with respect to the longitudinal axis.

4. The separator unit according to claim 3, wherein:
said filter cover has a circular contour with a flattened section; and
said mechanical position coding is formed by said flattened section of said filter cover.

5. The separator unit according to claim 1, further comprising an articulated joint, wherein said cover is pivotably mounted via said articulated joint about a pivot axis on said second end face of said collection container, and the pivot axis is compressed in an axial direction so that by compressing the pivot axis said cover is released from said collection container or attached to said collection container.

6. The separator unit according to claim 1, wherein said scraper element is configured to be moved along the longitudinal axis over said surface of said filter module.

7. The separator unit according to claim 6, further comprising an actuating element configured to act on said scraper element in order to move said scraper element along the longitudinal axis toward said second end side of said collection container over said surface of said filter module.

8. The separator unit according to claim 7, wherein said actuating element has a rod with a grip which is moved along the longitudinal axis in order to move said scraper element along the longitudinal axis over said surface of said filter module.

9. The separator unit according to claim 7,
further comprising a connecting piece extending away from said collection container along the longitudinal axis starting from said first end side of said collection container; and
wherein said actuating element is disposed in and/or on said connecting piece.

10. The separator unit according to claim 9,
further comprising a restoring spring disposed at least in part in said connecting piece and is configured to automatically move said actuating element and said scraper element away from said second end side of said collection container into a basic position; and
wherein said scraper element is disposed in the basic position on said first end side of said collection container.

11. The separator unit according to claim 6, wherein:
said scraper element is configured so as, when said cover of said collection container is closed, to be moved toward said second end side of said collection container in order to compress the particles of dirt disposed in said collection area of said collection container; and
said scraper element is configured so as, when said cover of said collection container is open, to be moved toward said second end side of said collection container in order to eject from said collection container the particles of dirt disposed in said collection area of said collection container.

12. The separator unit according to claim 11, further comprising a dedicated operating element for opening said cover, and the separator unit being configured in such a manner that said scraper element is moved toward said second end side of said collection container without said cover of said collection container being opened.

13. A suction apparatus, comprising:
said separator unit according to claim 1; and
a base unit with a blower configured to generate a suction airflow by way of said separator unit.

14. The suction apparatus according to claim 13,
further comprising a locking mechanism;
wherein said separating unit has an operating unit configured in such a manner that said operating element is pressed by a user in order to:
hold said separator unit; and
to release said locking mechanism with which said separator unit is attached to said base unit.

15. The suction apparatus according to claim 14, wherein:
said operating unit is disposed on a side wall of said collection container which is remote from said base unit and said side wall runs between said first end side and said second end side of said collection container; and
said locking mechanism is configured in such a manner that said separator unit is dismantled from said base unit along a dismantling direction, which runs perpendicular to the longitudinal axis of said separator unit.
